(19) United States
(12) Patent Application Publication
(10) Pub. No.: US 2008/0071055 A1
(43) Pub. Date: Mar. 20, 2008

(54) New liquid diisocyanates prepared via modification with 1,3-dicarbonyl compounds

(75) Inventors: Rick L. Adkins, Hurricane, WV (US); William E. Slack, Moundsville, WV (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 11/520,919

(22) Filed: Sep. 14, 2006

(51) Int. Cl. C08G 18/00

(52) U.S. Cl. 528/44

(57) ABSTRACT

This invention relates to novel liquid modified diisocyanate and/or polyisocyanate compositions and to a process for the preparation of these novel liquid modified diisocyanate and/or polyisocyanate compositions. These novel liquids comprise the reaction product of a diisocyanate and/or polyisocyanate component with at least one compound which corresponds to a specific structure and contains a 1,3-dicarbonyl group. These products are storage stable liquids.

### BACKGROUND OF THE INVENTION

This invention relates to novel liquid modified diphenylmethane diisocyanate compositions and to a process for the preparation of these novel liquid modified diisocyanate compositions.

U.S. Pat. No. 5,688,891 describes 1,3-dioxan-2-one group containing oligourethanes. These are prepared by reacting a) hydroxyl-functional 1,3-dioxan-2-ones with b) compounds which contain at least two isocyanate groups per molecule. The oligourethanes prepared by this process are suitable for the preparation of plastics, as binders or as a binder component in coating compositions. The hydroxyl-functional 1,3-dioxan-2-ones have a cyclic structure. A solvent may be present during the reaction.

Polyisocyanate compositions exhibiting low viscosities and high functionalities and a process for their preparation are disclosed in U.S. Pat. No. 6,730,405. These polyisocyanate compositions may be reacted with a compound comprising a mobile hydrogen, which are also known as masking agents. Masking agents are described as having at least one functional group carrying a mobile (or reactive) hydrogen, and the functional group should have a pKa of at least 4 to less than or equal to 14.

Blocked polyisocyanates and their preparation are described in U.S. Pat. No. 6,843,933. These blocked polyisocyanates react without elimination of the blocking agent (i.e. they are free of emissions), and possess low crosslinking temperatures (i.e. a high reactivity), and should be storage stable at ambient temperature. The polyisocyanates are blocked with a CH-acidic cyclic ketone which corresponds to a specific formula.

U.S. Pat. No. 6,750,310 discloses polyisocyanate compositions for fast cure. These polyisocyanates comprise a titanium complex in which the titanium complex consists of titanium and an acetoacetate ester in which the molar ratio of Ti to acetoacetate ester is from 1:2 to 1:8, and the acetoacetate ester is an ester of an alcohol containing 1 to 4 carbon atoms to accelerate the binding of lignocellulosic materials.

It has surprisingly been found that diisocyanates which are modified with 1,3-dicarbonyl compounds are liquids and storage stable at room temperature. It has also been found that these modified diisocyanates exhibit lower freezing points than the corresponding unmodified diisocyanates. Advantages of these modified diisocyanates include the ability of store and use them in processes without the need to maintain a >25° C. storage temperature.

### SUMMARY OF THE INVENTION

This invention relates to novel liquid, storage-stable modified diisocyanate composition, and to a process for the preparation of these novel liquid, storage-stable modified diisocyanate compositions.

The liquid, storage-stable modified diisocyanate compositions of the invention comprise the reaction product of:

### (A) at least one diisocyanate or polyisocyanate component, with

(B) at least one compound which corresponds to the structure:

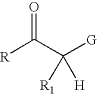

wherein:
G: represents an electron-withdrawing group, and preferably an electron-withdrawing group that leads to CH-acidity of the α-hydrogen, more preferably an ester group, an acetyl group, an acetate ester group, an amide group, a sulfoxide group, a sulfone group, a nitro group, a phosphonate group, a nitrile group, a isonitrile group, a carbonyl group, a polyhaloalkyl group or a halogen;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group;
and
R₁: represents a hydrogen atom, an alkyl group containing from 1 to 6 carbon atoms, or an aryl group containing 6 carbon atoms;
   in the presence of

### (C) at least one catalyst.

The present invention also relates to a process for the preparation of a liquid, storage-stable modified diisocyanates. This process comprises:

### (I) reacting

(A) at least one diisocyanate or polyisocyanate component, with
(B) at least one compound which corresponds to the structure:

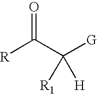

wherein:
   G: represents an electron-withdrawing group, preferably an electron-withdrawing group that leads to CH-acidity of the α-hydrogen, and more preferably an ester group, an acetyl group, an acetate ester group, an amide group, a sulfoxide group, a sulfone group, a nitro group, a phosphonate group, a nitrile group, a isonitrile group, a carbonyl group, a polyhaloalkyl group or a halogen;
   R: represents a hydrogen atom, an alkyl group containing from 1 to 5 carbon atoms, a cycloalkyl group containing from 5 to 6 carbon atoms, an aryl group containing 6 carbon atoms, or an alkoxyl group;
   and
   R₁: represents a hydrogen atom, an alkyl group containing from 1 to 6 carbon atoms, or an aryl group containing 6 carbon atoms;
in the presence of
(C) at least one catalyst.

In accordance with the present invention, diphenylmethane diisocyanate is a preferred diisocyanate. More specifically, it is preferred that the diphenylmethane diisocyanate comprises:
(1) from 0 to 6% by weight of the 2,2′-isomer of diphenylmethane diisocyanate,
(2) from 0 to 60% by weight of the 2,4′-isomer of diphenylmethane diisocyanate,
and
(3) from 34 to 100% by weight of the 4,4′-isomer of diphenylmethane diisocyanate,
with the sum of the %'s by weight of (1), (2) and (3) totaling 100% by weight of (A) the diphenylmethane diisocyanate.

### DETAILED DESCRIPTION OF THE INVENTION

As used in the present invention, the term liquid means that the carbonyl-modified diisocyanate or polyisocyanate product does not precipitate solids when stored at 25° C. for 3 months.

As used herein, the term “storage-stable” means that the carbonyl-modified diisocyanate or polyisocyanate product has up to a 1% absolute change in the % NCO group content and up to a 10% change in the viscosity when stored at 25° C. for 3 months.

The liquid, storage stable, modified diisocyanates of the present invention are typically characterized by an NCO group content of at least about 11% NCO, and preferably of at least about 14% NCO. These liquid diisocyanates are also typically characterized by an NCO group content or less than or equal to about 47% NCO, preferably less than or equal to about 32% NCO and more preferably less than or equal to about 30% NCO. The liquid modified diisocyanates may also have an NCO group content ranging between any combination of these upper and lower values, inclusive. For example, the liquid diisocyanates may have an NCO group content of from about 11% by weight NCO to about 47% by weight NCO, preferably from about 11% by weight NCO to about 32% by weight NCO and more preferably from about 14% by weight NCO to about 30% by weight NCO

In accordance with the present invention, the following components are, generally speaking, suitable.

Suitable diisocyanates and polyisocyanates to be used as component (A) herein include, for example, the known monomeric diisocyanates and polyisocyanates. The various monomeric diisocyanates may be represented by the formula R(NCO)₂ in which R represents an organic group obtained by removing the isocyanate groups from an organic diisocyanate having a molecular weight of about 56 to 1,000, preferably about 76 to 400. Diisocyanates preferred for the process according to the invention are those represented by the above formula in which R represents a divalent aliphatic, hydrocarbon group having 4 to 12 carbon atoms, a divalent cycloaliphatic hydrocarbon group having 6 to 13 carbon atoms, a divalent araliphatic hydrocarbon group having 7 to 20 carbon atoms or a divalent aromatic hydrocarbon group having 6 to 18 carbon atoms. Preferred monomeric diisocyanates are those wherein R represents an aromatic hydrocarbon group.

Examples of the suitable organic diisocyanates include 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis(4-isocya-natocyclohexyl) methane, 2,4′-dicyclohexylmethane diisocyanate, 1,3- and 1,4-bis(isocyanatomethyl) cyclohexane, bis(4-isocyanato-3-methyl-cyclohexyl) methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluene diisocyanate, 1,3- and/or 1,4-phenylene diisocyanate, 2,4- and/or 2,6-toluene diisocyanate, 2,2′-, 2,4′- and/or 4,4′-diphenylmethane diisocyanate, 1,5-diisocyanato naphthalene and mixtures thereof. Aromatic polyisocyanates containing 3 or more isocyanate groups such as 4,4′,4″-triphenylmethane triisocyanate and polymethylene poly(phenylisocyanates) obtained by phosgenating aniline/formaldehyde condensates may also be used.

Suitable di- and/or polyisocyanates to be in accordance with the present invention typically have NCO group contents from about 25 to about 60%. These di- and/or polyisocyanates typically have NCO group contents of at least about 25%, preferably at least about 30% and most preferably at least about 33%. The polyisocyanates suitable herein also typically have NCO group contents of less than or equal to 60%, preferably of less than or equal to 40% and most preferably of less than or equal to 34%. The polyisocyanates may have an NCO group content ranging between any combination of these upper and lower values, inclusive, e.g., from 25 to 60%, preferably from 30 to 40% and most preferably from 31 to 34%.

Preferred diisocyanates to be used in accordance with the present invention include those based on aromatic diisocyanates such as, for example, 1,3- and/or 1,4-phenylene diisocyanate, 2,4- and/or 2,6-toluene diisocyanate, 2,2′-, 2,4′- and/or 4,4′-diphenylmethane diisocyanate, 1,5-diisocyanato naphthalene and mixtures thereof. Of these, it is more preferred to use 2,4- and/or 2,6-toluene diisocyanate, or 2,2′-, 2,4′- and/or 4,4′-diphenylmethane diisocyanate.

A particularly preferred diisocyanate comprises diphenylmethane diisocyanate in which the 2,2′-isomer is present in an amount of from 0 to 6% by weight, preferably 0 to 3% by weight, and more preferably 0 to 1% by weight; the 2,4′-isomer is present in an amount of 0 to 60% by weight, preferably 0 to 17% by weight, and more preferably 0 to 5% by weight; and the 4,4′-isomer is present in an amount of from 34 to 100% by weight, preferably 80 to 100% by weight, and more preferably 94 to 100% by weight. When mixtures of the 2,2′-isomer, the 2,4′-isomer and the 4,4′-isomer of diphenylmethane diisocyanate are used, the sum of the %'s by weight of the individual isomers totals 100% by weight of the diphenylmethane diisocyanate.

Suitable compounds to be used as component (B) in accordance with the present invention include those compounds which correspond to the general structure:

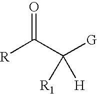

in which:
G: represents an electron withdrawing group; preferably an electron withdrawing group that leads to CH-acidity of the α-hydrogen; more preferably an ester group, an acetyl group, an acetate ester groups, an amide group, a sulfoxide group, a sulfone group, a nitro group, a phosphonate group, a nitrile group, a isonitrile group, a carbonyl group, a polyhaloalkyl group or a halogen atom;
R: represents a hydrogen atom, an alkyl group which contains from 1 to 5 carbon atoms, a cycloalkyl group which contains from 5 to 6 carbon atoms, an aryl group which contains 6 carbon atoms, or an alkoxyl group which contains from 1 to 10 carbon atoms;
and
R₁: represents a hydrogen atom, an alkyl group which contains from 1 to 6 carbon atoms, or an aryl group which contains 6 carbon atoms.

Some examples of compounds which are suitable to be used as component (B) herein include malonic dialdehyde, acetoacetaldehyde, 2-methylacetoacetaldehyde, dimethyl malonate, diethyl malonate, ethyl acetoacetate, tertiary-butyl acetoacetate, 2,4-pentanedione, 3-methyl-2,4-pentanedione, 1-nitro-2-propanone, N,N-dimethylacetoacetamide, etc.

It is preferred that a compound selected from the group consisting of malonic dialdehyde, diethyl malonate, 2,4-pentanedione, 3-methyl-2,4-pentanedione is used as component (B) in the present invention. Most preferred compounds are 1,3-diketones such as 2,4-pentanedione.

In a preferred embodiment of the invention, it is preferred to react from 0.01 mole of component (B) per equivalent of component (A) up to 1 mole of component (B) per equivalent of component (A) in preparing the liquid, storage stable, modified diisocyanates of the invention.

In accordance with the present invention, a suitable catalyst may be present. Some examples of such catalysts include, but are not limited to, zinc acetylacetonate, zinc 2-ethylhexanoate, and other common zinc compounds, tin octanoate, dibutyltin dilaurate, and other common tin compounds, cobalt naphthanate, lead linoresinate, titanium 2-ethylhexanoate and other titanium (IV) compounds, zirconium 2-ethylhexanoate and other common zirconium (IV) compounds, bismuth 2-ethylhexanoate and other common bismuth compounds. The catalyst is typically used in an amount of at least about 50 ppm, and preferably at least about 100 ppm, based on the weight of isocyanate compound. The catalyst is also typically used in an amount of less than or equal to 5000 ppm, and more preferably of less than or equal to about 1000 ppm, based on the weight of the isocyanate compound. The catalyst may be present in an amount ranging between any combination of these upper and lower values, inclusive. For example, the catalyst may be present in an amount of from 50 ppm to 5000 ppm, and more preferably from about 100 ppm to 1000 ppm, based on the isocyanate compound.

Generally, the process of preparing the liquid, storage stable di- and/or poly-isocyanates of the invention comprises reacting (A) a suitable di- or polyisocyanate component, with (B) a compound which corresponds to the specified structure in which G, R and R1 are defined as set forth above, in the presence of a catalyst. The reaction typically is at a temperature of at least about 50° C., and more preferably at least about 70° C. The reaction also typically is at a temperature of less than or equal to 150° C., and more preferably less than or equal to 120° C. The reaction may occur at a temperature between any combination of these upper and lower values, inclusive. For example, the reaction may occur at a temperature of from 50 to 150° C., and more preferably of from 70 to 120° C.

In accordance with one embodiment of the present invention, the liquid, storage-stable diisocyanates may correspond to the structure:

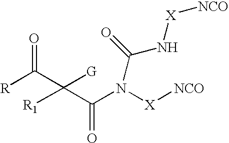

in which:
X: represents an organic group obtained by removing the isocyanate groups from an organic diisocyanate;
G: represent an electron withdrawing group; preferably an electron-withdrawing group that leads to CH-acidity of the α-hydrogen; more preferably an ester group, an acetyl group, an acetate ester group, an amide group, a sulfoxide group, a sulfone group, a nitro group, a phosphonate group, a nitrile group, a isonitrile group, a carbonyl group, a polyhaloalkyl group or a halogen;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group;
and
R₁: represents a hydrogen atom, an alkyl group containing from 1 to 6 carbon atoms, or an aryl group containing 6 carbon atoms.

In another preferred embodiment of the present invention, the liquid, storage-stable diisocyanates of the invention correct to the structure:

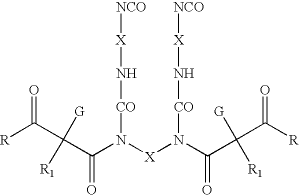

in which:
X: represents an organic group obtained by removing the isocyanate groups from an organic diisocyanate;
G: represent an electron withdrawing group; preferably an electron-withdrawing group that leads to CH-acidity of the α-hydrogen; more preferably an ester group, an acetyl group, an acetate ester group, an amide group, a sulfoxide group, a sulfone group, a nitro group, a phosphonate group, a nitrile group, a isonitrile group, a carbonyl group, a polyhaloalkyl group or a halogen;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group;
and
R₁: represents a hydrogen atom, an alkyl group containing from 1 to 6 carbon atoms, or an aryl group containing 6 carbon atoms.

The modified isocyanate compositions of the present invention may be reacted with one or more isocyanate-reactive components to form, for example, polyurethanes and/or polyureas.

The following examples further illustrate details for the preparation of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

The following components were used in the working examples of this application.

| | |
|---|---|
| Isocyanate A: | 4,4′-diphenylmethane diisocyanate |
| Dicarbonyl A: | diethyl malonate |
| Dicarbonyl B: | ethyl acetoacetate |
| Dicarbonyl C: | 2,4-pentanedione |
| Catalyst A: | zinc acetylacetonate |
| Catalyst B: | zinc-2-ethylhexanoate |
| Catalyst C: | tin octanoate (T-9) |

In a suitable flask, were added 250 g of Isocyanate A and the 1,3-dicarbonyl compound, followed by heating to 60° C. under nitrogen. The catalyst (300 ppm) was added, and the mixture heated at 90° C. for 4 hours to reach theoretical % NCO. Table 1 shows the results.

TABLE 1

| | | Dicarbonyl | | |
|---|---|---|---|---|
| Example | Isocyanate | Compound | Catalyst | % NCO |
| Example 1 | Isocyanate A | Dicarbonyl A (17 g) | Catalyst A | 26 |
| Example 2 | Isocyanate A | Dicarbonyl B (15 g) | Catalyst B | 28 |
| Example 3 | Isocyanate A | Dicarbonyl B (15 g) | Catalyst C | 28 |
| Example 4 | Isocyanate A | Dicarbonyl C (11 g) | Catalyst B | 26 |

Examples 1-4 all resulted in liquid MDI products at room temperature. In particular, the isocyanate prepared in Example 4 had a freezing point of 10° C. By comparison, 4,4′-diphenylmethane diisocyanate that is not modified freezes at 42 to 44° C.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A liquid, storage-stable diisocyanate comprising the reaction product of:
(A) at least one diisocyanate or polyisocyanate component; and
(B) a compound corresponding to the structure: 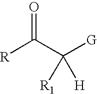
wherein:
G: represents an electron-withdrawing group;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group which contains from 1 to 10 carbon atoms;
and
R₁: represents a hydrogen atom, an alkyl group containing from 1 to 6 carbon atoms, or an aryl group containing 6 carbon atoms;
in the presence of
(C) at least one catalyst.

2. The liquid, storage-stable diisocyanate of claim 1, wherein G represents an electron-withdrawing group which leads to CH-acidity of the α-hydrogen.

3. The liquid, storage-stable diisocyanate of claim 1, wherein G represents an ester group, an acetyl group, an acetate ester group, an amide group, a sulfoxide group, a sulfone group, a nitro group, a phosphonate group, a nitrile group, an isonitrile group, a carbonyl group, a polyhaloalkyl group or a halogen atom.

4. The liquid, storage-stable diisocyanate of claim 1, wherein component (A) comprises diphenylmethane diisocyanate which comprises (1) from 0 to 6% by weight of the 2,2′-isomer, (2) from 0 to 60% by weight of the 2,4′-isomer, and (3) from 34 to 100% by weight of 4,4′-isomer, with the sum of the %'s by weight of (1), (2) and (3) totaling 100% by weight of (A) the diphenylmethane diisocyanate.

5. The liquid, storage-stable diisocyanate of claim 1, which is characterized by an NCO group content of from about 11 to about 47% by weight.

6. A liquid, storage-stable diisocyanate corresponding to the structure: 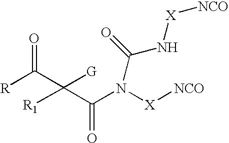
wherein:
X: represents an organic group obtained by removing the isocyanate groups from an organic diisocyanate;
G: represents an electron-withdrawing group,
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R₁: represents a hydrogen atom, an alkyl group containing from 1 to 6 carbon atoms, or an aryl group containing 6 carbon atoms.

7. The liquid, storage-stable diisocyanate of claim 6, wherein:
X: represents an organic group obtained by removing the isocyanate groups from diphenylmethane diisocyanate;
G: represents an electron-withdrawing group which leads to CH-acidity of the α-hydrogen;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R₁: represents a hydrogen atom, an alkyl group containing from 1 to 6 carbon atoms, or an aryl group containing 6 carbon atoms.

8. A liquid, storage-stable diisocyanate corresponding to the structure: 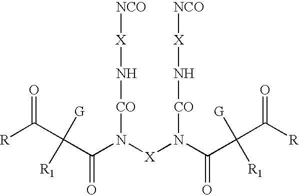
wherein:
X: represents an organic group obtained by removing the isocyanate groups from an organic diisocyanate;
G: represents an electron-withdrawing group;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R₁: represents a hydrogen atom, an alkyl group containing from 1 to 6 carbon atoms, or an aryl group containing 6 carbon atoms.

9. The liquid, storage-stable diisocyanate of claim 8, wherein:
X: represents an organic group obtained by removing the isocyanate groups from diphenylmethane diisocyanate;
G: represents an electron-withdrawing group which leads to CH-acidity of the α-hydrogen;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R₁: represents a hydrogen atom, an alkyl group containing from 1 to 6 carbon atoms, or an aryl group containing 6 carbon atoms.

10. A process for the preparation of a liquid, storage-stable diisocyanate comprising reacting:
(A) at least one diisocyanate or polyisocyanate component; with
(B) a compound corresponding to the structure: 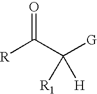
wherein:
G: represents an electron-withdrawing group;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R1: represents a hydrogen atom, an alkyl group containing from 1 to 6 carbon atoms, or an aryl group containing 6 carbon atoms;
in the presence of
(C) at least one catalyst.

11. The process of claim 10, wherein G represents an electron-withdrawing group which leads to CH-acidity of the α-hydrogen.

12. The process of claim 10, wherein G represents an ester group, an acetyl group, an acetate ester group, an amide group, a sulfoxide group, a sulfone group, a nitro group, a phosphonate group, a nitrile group, an isonitrile group, a carbonyl group, a polyhaloalkyl group or a halogen atom.

13. The process of claim 10, wherein component (A) comprises diphenylmethane diisocyanate which comprises (1) from 0 to 6% by weight of the 2,2′-isomer, (2) from 0 to 60% by weight of the 2,4′-isomer, and (3) from 34 to 100% by weight of 4,4′-isomer, with the sum of the %'s by weight of (1), (2) and (3) totaling 100% by weight of (A) the diphenylmethane diisocyanate.

14. The process of claim 10, in which the resultant liquid storage-stable diisocyanate is characterized by an NCO group content of from about 11 to about 47% by weight.

15. The process of claim 10, wherein the resultant liquid, storage-stable diisocyanate corresponds to the structure: 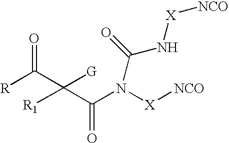
wherein:
X: represents an organic group obtained by removing the isocyanate groups from an organic diisocyanate;
G: represents an electron-withdrawing group,
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R₁: represents a hydrogen atom, an alkyl group containing from 1 to 6 carbon atoms, or an aryl group containing 6 carbon atoms.

16. The process of claim 10, wherein the resultant liquid, storage-stable diisocyanate corresponds to the structure: 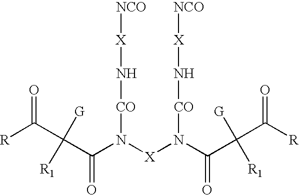
wherein:
X: represents an organic group obtained by removing the isocyanate groups from an organic diisocyanate;
G: represents an electron-withdrawing group;
R: represents a hydrogen atom, an alkyl group containing from 1 to 5 carbon atoms, a cycloalkyl group containing from 5 to 6 carbon atoms, an aryl group containing 6 carbon atoms, or an alkoxyl group containing from 1 to 10 carbon atoms;
and
R₁: represents a hydrogen atom, an alkyl group containing from 1 to 6 carbon atoms, or an aryl group containing 6 carbon atoms.

17. In a process for the preparation of polyurethane comprising reacting a polyisocyanate component with an isocyanate-reactive component, the improvement wherein said polyisocyanate component comprises the liquid, storage-stable diisocyanate of claim 1.
